(19) United States
(12) Patent Application Publication
(10) Pub. No.: US 2002/0099659 A1
(43) Pub. Date: Jul. 25, 2002

(54) Integrated full service employer and employee system and a method for accessing accounts

(76) Inventor: David B. Swentor, Mount Pleasant, SC (US)

Correspondence Address: John B. Hardaway, III, HARDAWAY/MANN IP GROUP, NEXSEN PRUET JACOBS & POLLARD, LLC, P.O. Box 10107 , Fed. Sta., Greenville, SC, 29603-0107, US

(21) Appl. No.: 09/754,929

(22) Filed: Jan. 4, 2001

(51) Int. Cl. G06F 17/60

(52) U.S. Cl. 705/44

(57) ABSTRACT

This disclosure describes an integrated full service employer and employee system and a method for employers and employees to access accounts on that system. The term “full service” refers to the fact that the employer, employer organizational entities, employees, and authorized third parties are able at various levels of authorization and participation to at least create, access and revise policies, rules, procedures, payroll, benefits, banking, investment, retirement, insurance, merchandising, and information capabilities of the integrated system described herein. The creation, access and revision policies are supported via an integrated privileges and security mechanism on a per-user basis where a user may be a representative of the employer, employer organizational entity, employee, or an authorized third party. Moreover, this system also provides for integration and automation with respect to other systems in order to enable interactions with other product and service providers. These other product and service providers may provide a broad range of financial activities including at least banking, investment, retirement, insurance, communication, and merchandising capabilities in addition to any of those resident within the system itself.

### FIELD OF THE INVENTION

The present invention relates generally to financial transaction, analysis, and management systems as well as human resource information systems. More specifically the invention relates to the integration of a series of services that enable employers, employer organizational entities, employees, and authorized third parties to create, access, and revise policies, rules, procedures, payroll, benefits, banking, investment, retirement, insurance, and merchandising at various levels of authorization and participation via a consistent method of access.

### BACKGROUND OF THE INVENTION

A number of factors have contributed to the exponentially increased complexity associated with both employer and employee business and financial products and services. The diversification of the financial industry due to the on going deregulation of that industry has caused an exponential increase in the sheer number of products and services. The rapid inflow of capital into high technology companies and the increasing capitalization of these companies have dramatically increased the number of point products and services in this area for both employers and employees. Moreover, the combination of deregulation and increased capital has resulted in these point product vendors and services attempting to increase their market share by incorporating features of their competitors.

In addition, there is a broad trend toward an expectation of increased productivity on a per-employee basis as employers seek to continually increase their product and services offerings in an increasingly competitive environment. This expectation of increased productivity means that employees must significantly increase the results associated with their jobs, and in many cases increase the raw number of hours dedicated to their employers. This need for increased results and potentially increased hours means that employees must be able to interact with their employer in many more ways than the past. This includes being able to access both corporate and personal data on a 24×7×52 (24 hours by 7 days per week by 52 weeks per year) basis and being better able to transform that data to information and knowledge rapidly via the increased semantic context of that data.

Despite the growth of all of these financial products and services and the increased urgency with respect to per-employee productivity, the options available to employers and employees with regard to their interdependent relationship have been relatively stagnant. One reason for this is that the plethora of products and services available to both employers and employees must be managed largely as a separate collection of entities rather than as an integrated system. This puts both the employer and the employee in the position of being in effect separate system integrators for the products and services that each opts to utilize.

When a company begins operations, the company owner or owners must fill out a series of governmentally mandated and third party forms relating to various attributes of that business. Each time an employee is hired by an employer, the employee fills out a series of governmentally mandated and employer-specific forms relating to various attributes of that employee. Once an employee begins work for the employer, various attributes associated with the attributes of that employee's employment must also be continuously maintained. Each of these activities is a completely separate and autonomous operation.

After the employee fully commences employment with the employer, the number of interactions between the employer and employee significantly increase. These interactions include minimally payroll with various routing features (tax withholding, benefits, insurance, direct deposit, etc.), health insurance reimbursement, policy and procedure access, forms access, employee performance monitoring, employee satisfaction monitoring, scheduling of resources (e.g., people, conference rooms, equipment, etc.), purchasing on behalf of the employer, scheduling of personal vacation, and approval of business- and project-specific documents.

There are several inventions that address an integrated financial system for a business or for an individual.

U.S. Pat. No. 6,131,810 discloses an integrated financial system that includes a single individual customer account that permits a customer to perform various financial transactions and includes at least banking and brokerage components. Thus, this invention addresses the individual without respect to the employment of that individual, if any.

U.S. Pat. No. 5,875,435 discloses an automated accounting system for an entity, such as an individual or business, in which at least one file is established for the entity and a plurality of data inputs are provided to the file. This invention is limited to both accounting systems and does not take into account integration between an employer and that employer's employees. Also, see U.S. Pat. No. 6,108,641, which discloses a computer system for managing a plurality of accounts separated into a master account and at least one sub-account associated with that master account—this invention is limited in its scope of integration and is focused on the individual only.

U.S. Pat. No. 6,128,602 discloses an open architecture system that automatically consolidates information from a plurality of financial systems into a single accounting system without the need for expensive and time-consuming backroom procedures. U.S. Pat. No. 6,058,378 discloses a method for integrating a plurality of financial services provided at different geographical locations and in different time zones, and electronic delivery of such services directly to a customer facility at any time requested by the customer. Both of these patents are restricted to businesses and the customers of those businesses.

Finally, U.S. Pat. No. 6,058,378 discloses a payment and disbursement system. This invention is a routing mechanism rather than an integrated system.

There are numerous point products and services available from software application and service provision vendors that address some of the specific issues associated with employer systems or employee systems. Some of these are very specific while others manage multiple aspects of either the employer or the employee. These software applications and services are inherently limited by the fact that all draw a basic distinction between the employer and the employee rather than resolving both the employer and employee in an integrated system.

There are three aggregated categories of software application and service provision vendors for employers and employees. The first category consists of those vendors providing human resource information systems and financial transaction, analysis, and management products and services to employers. The second category consists of those vendors providing financial transaction, analysis, and management systems to employees. The third category consists of those vendors providing what is in essence an intermediary routing products and services between employers and employees. Examples of the leading and most comprehensive vendor or vendors in each category will be explored in the paragraphs that follow.

PeopleSoft offers a wide variety of human resource information and management systems to employers as well as more recently offering workforce analytics, supply chain, financial management, and other employer-oriented products. PeopleSoft, like BAAN, SAP, Oracle, and other vendors in this category focused on capturing inter- and intra-business interactions.

The other major type of vendor in this category are custom software development companies such as marchFIRST, Sapient, Scient, and others that focus on building Intranet web sites (also called company portals) that attempt to enable so-called “knowledge management” among employees. These Intranet web sites are an attempt to address the broad trend previously mentioned with respect to increased productivity of employees.

The leading vendor in the employee-oriented second category is Intuit with its Quicken products, although Microsoft with its Money product and the banking and brokerage industry with its increasing variety of account management products and services are also powerful members of this category.

The third category are those vendors that are providing products and services for intermediary based routing between employers and employees. There are two basic types of vendors in this category: the traditional payroll vendor and the relatively new so-called “single source” vendors that offer either employers or employees a series of services. Each of these will be discussed below.

The traditional payroll vendor is represented by vendors such as ADP, Paychex, or local accounting firms that provide these services on a one-off basis to employers in geographically co-resident areas. Each of these vendors focuses entirely upon the employer and provides integrated payroll services to the subscribing employer. In addition, many of these types of vendors have also begun offering other services such as retirement plans, human resource forms and supplies, employee handbooks, and the like. The traditional payroll vendor enables an employer to codify and then enact the routing of an employee paycheck into various categories including federal taxes, state taxes, health insurance, life insurance, supplemental insurance, short term disability, long term disability, retirement plans, employee stock options, and direct deposit.

The single source vendors are represented by vendors such as BrightLane.com and WageMarket. BrightLane.com is oriented toward providing businesses with both traditional payroll services as well as banking, benefits financial services, insurance, office products and supplies, recruiting, and web services. WageMarket is oriented toward providing a more flexible routing scheme than traditional payroll vendors provide by enabling employees to route their paychecks to purchases, savings and investment, bill payment, and credit and debit cards. All of these single source vendors are focused once again on either the employer or the employee, and at best offer only a slightly more flexible routing scheme for payroll.

### SUMMARY OF THE INVENTION

It is thus an object of this invention to provide an improved full service employer and employee system that integrates the interactions among the employer and employees. It is a further object to provide such a system that provides not just the needs of an employer or just the needs of the individuals employed by the employer.

These objects, as well as others, are accomplished by an integrated full service system between an employer, the employer organizational entities, and the employees of that employer and its organizational entities. The present invention is characterized by the integration of a variety of services to employers, employer organizational entities, and the employees of each of those employers and a system and method for making those services available to those employers, employer organizational entities, and employees in a consistent manner.

The present invention enables the offering of at least integrated accounting, benefits, insurance, banking, merchandising, and information services to employers, employer organizational entities, and the employees of those employers.

### BRIEF DESCRIPTION OF THE DRAWINGS

The accompanying drawings are included to provide a further understanding of the invention, are incorporated and constitute a part of this specification, illustrate preferred embodiments of the invention, and, together with the description, serve to explain the principles of the invention.

There are three basic categories of drawings.

Block diagrams: FIG. 1 through FIG. 6. The block diagrams depict the system and subsystem relationships of the present invention.

Content and relationship diagrams: FIG. 7 through FIG. 15. The content and relationship diagrams depict the employer, employer organizational entity, and employee sample fields and relationships of the present invention.

Flow diagrams: FIG. 16A through FIG. 26. The flow diagrams depict the session-oriented access and management of the integrated employer and employee database of the present invention.

In the drawings,

FIG. 1 is a block diagram of an integrated full service employer and employee system in accordance with one embodiment of the present invention, as shown in FIGS. 2A and 2B.

FIGS. 2A and 2B are block diagrams of an integrated full service employer and employee system.

FIG. 3 is a block diagram of the integration and business logic systems, in accordance with a preferred embodiment of the present invention, as shown in FIGS. 2A and 2B.

FIG. 4 is a block diagram of the accounting, benefits, insurance, banking, merchandising, information systems, and other services, as they exist in the integration and business logic systems, in accordance with a preferred embodiment of the present invention.

FIG. 5 is a block diagram of the accounting, benefits, insurance, banking, merchandising, information systems, and other services, as they exist in the integration system, in accordance with a preferred embodiment of the present invention.

FIG. 6 is a block diagram of the accounting, benefits, insurance, banking, merchandising, information systems, and other services, as they exist in the business logic system, in accordance with a preferred embodiment of the present invention.

FIG. 7 is a sample of the contents of the employer section of the present invention that is shown in FIGS. 2A and 2B.

FIG. 8 is a sample of the contents of the employer organization section of the present invention that is shown in FIGS. 2A and 2B.

FIG. 9 is a sample of the contents of the employee section of the present invention that is shown in FIGS. 2A and 2B.

FIG. 10 is a high-level example of employer, employer organization, and employee information relationships of the present invention as shown in FIGS. 2A and 2B.

FIG. 11 is an example of employer-to-organization inheritance relationship between the employer organization and employer sections of the present invention as shown in FIGS. 2A and 2B.

FIG. 12 is an example of an override with organization-specific information relationship between the employer organization and employer sections of the present invention as shown in FIGS. 2A and 2B.

FIG. 13 is an example of an employer-to-organization augmentation relationship between the employer organization and employer sections of the present invention as shown in FIGS. 2A and 2B.

FIG. 14 is an example of an employee-to-employer non-inheritance link relationship between the employee and employer sections of the present invention as shown in FIGS. 2A and 2B.

FIG. 15 is an example of an employee-to-employer unique relationship between the employee and employer sections of the present invention as shown in FIGS. 2A and 2B.

FIGS. 16A and 16B are flow diagrams of a method of handling the request of an individual to access the employer and employee integrated full service system, in accordance with an embodiment of the invention.

FIG. 17 is a flow diagram of a method of identifying the customer, in accordance with the flow diagrams shown in FIGS. 16A and 16B.

FIG. 18 is a flow diagram of a method of classifying the type of customer contact, in accordance with the flow diagrams shown in FIGS. 16A and 16B.

FIG. 19 is a flow diagram of a method of getting the fundamental method of access and management of the employer (or employer-based organization) account of the integrated employer and employee meta-account, in accordance with an embodiment of the invention.

FIG. 20 is a flow diagram of a method for creating an employer (or employer-based organization) account of the integrated employer and employee meta-account, in accordance with an embodiment of the invention.

FIG. 21 is a flow diagram of a method for deleting an employer (or employer-based organization) account of the integrated employer and employee meta-account, in accordance with an embodiment of the invention.

FIG. 22 is a flow diagram of a method for modifying an employer (or employer-based organization) account of the integrated employer and employee meta-account, in accordance with an embodiment of the invention. Please note that a modification is a superset of a simple read operation and is thus the read operation is implicitly included in this figure.

FIG. 23 is a flow diagram of a method of getting the fundamental method of access and management of the employee account of the integrated employer and employee meta-account, in accordance with an embodiment of the invention.

FIG. 24 is a flow diagram of a method for creating an employee account of the integrated employer and employee meta-account, in accordance with an embodiment of the invention.

FIG. 25 is a flow diagram of a method for deleting an employee account of the integrated employer and employee meta-account, in accordance with an embodiment of the invention.

FIG. 26 is a flow diagram of a method for modifying an employee account of the integrated employer and employee meta-account, in accordance with an embodiment of the invention. Please note that a modification is a superset of a simple read operation and is thus the read operation is implicitly included in this figure.

### DETAILED DESCRIPTION

In accordance with the present invention it has been found that the complexity and thus the time and cost associated with employers, employer organizational entities, and employees managing separate employer and differentiated and individual employee accounts may be greatly reduced. The present invention enables employers, employer organizational entities, and employees to dismiss themselves from their role of a system integrator of the wide variety of products and services available. This enables both employers and the employees of those employers to spend additional time achieving both their combined and exclusive objectives, thus increasing the productivity of both.

Since the present invention is fully integrated, it provides operating efficiencies and cost reductions to the employer and the organizational entities of that employer. The present invention promotes a cycle of increased efficiency and cost savings that benefits the employer.

The present invention also offers the employer or some other entity the possibility of additional sources of revenue through at least accounting, benefits, insurance, banking, merchandising, and information third party relationships. In addition, advertising revenues may be realized by the employer or some other entity through the aggregation of multiple employers and employees.

Each employer, employer organizational entities, and the employees of the employer are represented in this system via a “meta-account”. Depending upon the specific embodiment of the invention (i.e., whether the invention is delivered as a product or a service), there may be one or more of these meta-accounts present in a given system.

Each meta-account contains a single account for the employer, zero or more accounts that represent some type of employer organizational entity within that employer, and zero or more accounts that represent specific employees associated with the employer. Organizational entity accounts may be nested to any level.

Each of the employer, employer organizational entity, and employee accounts is linked in an integrated fashion. Employee accounts inherit attributes from the top-most organizational entity accounts, which in turn inherit attributes from the next top-most organizational entity accounts, and this repeats until the baseline employer account is reached. This inheritance of attributes at multiple levels is necessary

Each employer, employer organizational entity, and employee account may consist of at least an accounting module, a benefits module, an insurance module, a banking module, a merchandising module, and an information module. Each of these modules consists of data, and the semantic context of that data is the account type and specific account in which that data resides. Thus, the accounting module and its associated data that is associated with an employee may be very different than the accounting module and associated data that is associated with the employer of that employee.

In one embodiment a consistent and easy to use user interface is available for employers, employees, and authorized third parties. This interface may be delivered at least by any number of interface devices. Because this invention is intended for use by a broad range of employers, employees, and authorized third parties, it is an important feature of this invention that it be available through voice telephony as well as through computerized interface devices.

Invention may be available and accessed 24×7×52 (24 hours by 7 days per week by 52 weeks per year), thus allowing complete access to the system at all times. It can be available for geographical distribution such that complete access to the system would be uninterrupted in case of a major disaster at the primary operational site. Such distribution may be via the Internet, thus allowing complete access to the system worldwide.

Employers, employees, and authorized third party entities may have differing access to information processed and stored by the system. Unauthorized entities may be prevented access through a privilege and security system.

The elements and components of the system according to the present invention can be implemented using software, hardware, or a combination thereof. Moreover, the elements and components of the system may be implemented with a single computer, multiple computers within a distributed network, or any appropriate configuration of software, hardware, or both as may be apparent to one of skill in the art. Thus the services of the system may be delivered via both hardware and software components to the premises of an entity (the delivery of a product) and/or through a services-based infrastructure (a service provider).

The system according to the present invention may be integrated with an entity's existing computerized business systems, for example, by exchanging data with personnel, accounting, benefits, insurance, banking, merchandising, information, and/or other computerized systems already in place within the entity.

Various other aspects and advantages of the invention will become apparent from the following description given with reference to the various figures of drawing.

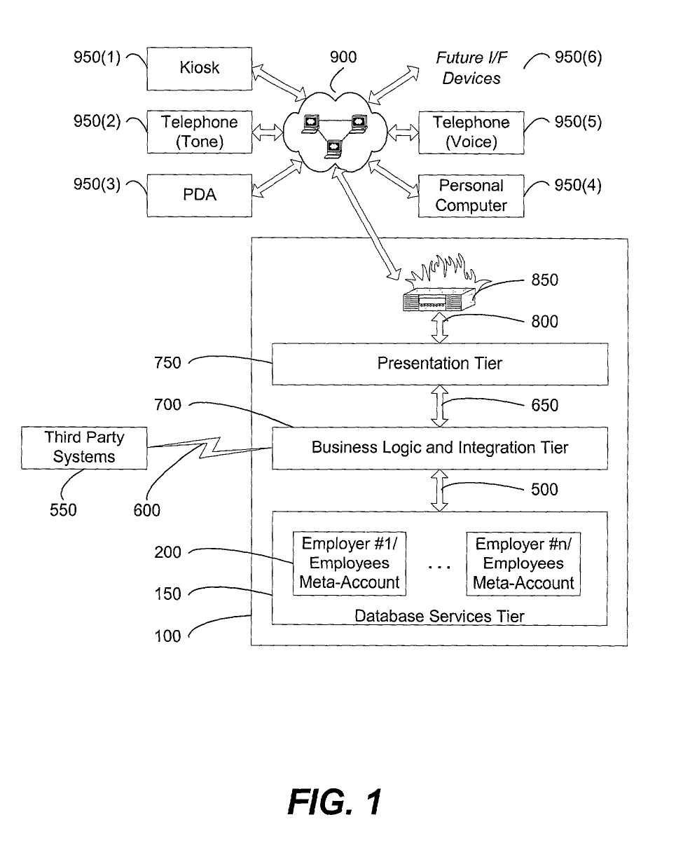

FIG. 1 provides a high level overview of the present invention. System 100 includes a standard logical n-tier architecture represented by the presentation tier 750, a business logic and integration tier 700, and a services tier 150. System 100 may interact in a direct manner via the network 900 and in an indirect manner via the network 600.

Interaction with the network 900 may be accomplished through a standard firewall 850 that with the software and protocols associated with interface 800 provides a secure interface to the interface devices connected to network 900. Thus, the network 900 may be an Internet, Intranet, Extranet, or any other standard or proprietary network and may be wire-based or wireless. If the network 900 is an open network, then the firewall 850 may not be necessary and may be not be present in the system.

The interface devices, represented by interface devices 950(1) through 950(6), may be used directly by the customers of the system or may be used by back-office personnel servicing the customers of the system. This is particularly important because many of the customers of this system may not be comfortable in directly accessing the system 100 and thus trained customer service representatives are accommodated in order to operate the system and provide services on behalf of those customers. In any case, the interface devices depicted herein are provided as examples only; as interface device 950(6) shows, future interface devices are explicitly supported as they are developed as long as these interface devices operate on any type of network.

Interaction with third party systems 550 is achieved via the interconnect 600. This interconnect may be any type of network, including Internet, Intranet, Extranet, or any other standard or proprietary network and may be wire-based or wireless. If the interconnect 600 is achieved through a proprietary network, then no security measure such as a firewall will be necessary. If the interconnect 600 is achieved as an open network, then a firewall must be used in order to protect the security and integrity of the system 100.

The presentation tier 750 is responsible for both input and output of data and information between system 100 and the interface devices 950(1) through 950(6). The output of data and information includes the responsibility for the formatting of data and information for display by the interface devices 950(1) through 950(6). This presentation tier includes support for any protocol and language, including but not limited to HTTP, HTML, DHTML, XML, SOAP, and UDDI. Common presentation tier products include Microsoft IIs, Apache, Netscape-Enterprise, Rapidsite, WebSite Pro, thttpd, Stronghold, WebSTAR, NCSA, and Netscape-Commerce.

The business logic and integration tier 700 has two primary functions: the provision of business logic rules processing for the system 100 and the provision of integration of third party systems 550 with system 100. The business logic function uses interface 650 to communicate with the presentation tier 750 and the interface 500 to communicate with the database services tier 150. The integration function uses interface 600 to communicate with third party systems 550 and with the database services tier 150. Common second tier products focused on business rule encapsulation and integration include BEA WebLogic, Microsoft IIS, iPlanet Application Server, IONA iPortal Application Server, IBM Websphere, Oracle 9i, and Silver Stream Application Server. Common second tier products focused on integration include Microsoft BizTalk Server, BEA E-Collaborate, and Bluestone Total-e-B2B.

Interface 650 may be any protocol and language, up to and including the tight integration at either or both a hardware and software level of the presentation tier and the business logic and integration tier. Interface 500 may be any protocol and language. Either the protocols and languages are defined as including the tight integration at either or both a hardware and software level of the business logic and integration tier and the database services tier. Common interface protocols and languages used to implement interface 500 include but are not limited to TCP/IP, ATM, SQL, and database interfaces unique to merchant database products from companies such as Oracle, Microsoft, Sybase,

The database services tier 150 is the core of the present invention and incorporates the integrated employer and employee system in the form of the series of meta-accounts 200. These meta-accounts are the exclusive subjects of the next two figures.

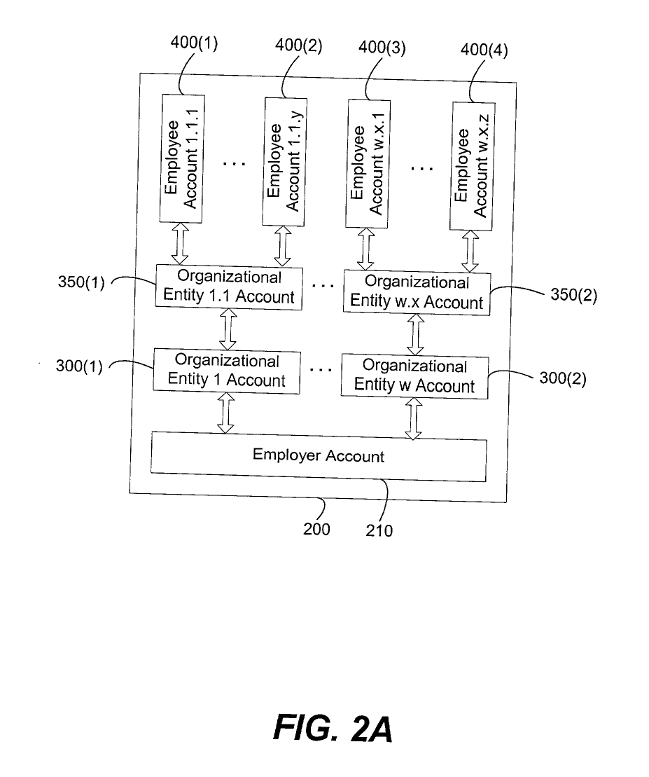

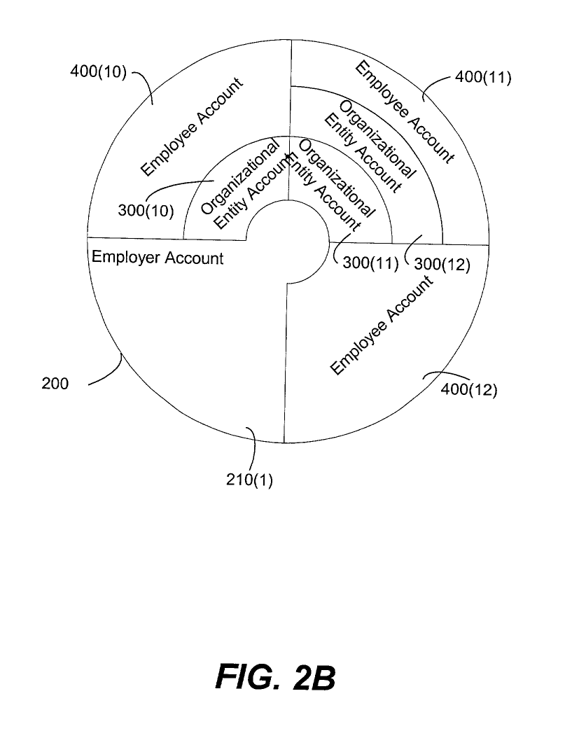

FIG. 2A and 2B are block diagram depictions of the meta-account structure of the present invention. FIG. 2A depicts the major components of the meta-account structure 200. This meta-account structure is hierarchical in nature with implicit and explicit relationships among the accounts within each meta-account. The employer account 210 always forms the base account from which all other accounts are derived. This employer account represents the highest-level representation of the employer. In other words, the employer account represents the entire corporate structure.

There may optionally be one or more organizational entities contained within a corporate structure, and there may optionally be one or more organizational entities contained within a higher level organizational entity, and so on. This is depicted in the figure by organizational entity accounts 300(1), 300(2), 350(1), and 350(2). Note that these organizational entity accounts are illustrative in nature in this depiction; as noted earlier, they need not exist at all, more than these might exist, and a deeper nesting of organizational entities may exist.

The organizational entity accounts 300(1) and 300(2) are based upon the employer account 210. Thus, these organizational entity accounts represent firstlevel sub-corporate entities. For example, if company A formed the base employer account 210, for example, the organizational entity accounts represented by 300 would represent the major businesses of the company, e.g., aircraft engines, appliances, capital services, aviation services, and other company A businesses.

The organizational entity accounts 350(1) and 350(2) are based upon the organizational entity accounts 300(1) and 300(2), respectively. Thus, these organizational entity accounts represent second-level sub-corporate entities based upon the first-level sub-corporate entities described in the previous paragraph. In the example in the previous paragraph, where company A was the base employer account and capital services would be a first-level sub-corporate entity, these second-level sub-corporate entities might be organized by industry vertical, e.g., Industrial and Manufacturing, Auto Dealers, Insurance, Real Estate, and other company A Capital Services verticals.

The number of organizational entities may be nested to any depth to meet the needs of the corporate entity as a whole. In addition, the number of organizational entities may be changed to reflect changing regulatory, competitive, and other internal and external changes made in the overall corporate structure.

The employee accounts 400(1), 400(2), 400(3), and 400(4) in this depiction are based upon the highest-level second-level sub-corporate entities discussed in previous paragraphs. Each employee account represents an individual employee of the company. There may be any number of employee accounts, from zero to many, for each organizational entity. Thus, employee accounts may be based upon the base employer account 210, the first-level organizational entity accounts 300, the second-level organizational entity accounts 350, and any other n-level organizational entity account.

FIG. 2B depicts another view of the structure of the integrated employer and employee meta-account structure. In this figure, the overall integrated employer and employee meta-account is represented by 200. The base employer account 210(1) as shown not only represents the base account in an n-level organizational entity account structure but also has employee account 400(12) based directly upon it. A simple example of a typical employee account that might be based directly upon the employer account 210(1) would be that of the chief executive officer of the overall corporate entity.

There are two first-level organizational entity accounts 300(10) and 300(11) that are based upon the employer account 210(1). The organizational entity account 300(10) has the employee account 400(10) directly based upon it. A simple example of a typical employee account at this level might be an executive vice president and business unit leader of a sub-corporate entity reporting to the chief executive officer of the overall corporate entity.

The organizational entity account 300(12) is based upon organizational entity account 300(11). This represents a second-level corporate entity based upon a first-level corporate entity. The employee account 400(11) is based upon organizational entity account 300(12). A simple example of a typical employee account at this level might be an assistant reporting to the executive vice president level noted above.

As discussed, FIGS. 2A and 2B represent the capabilities of the present invention in terms of the integrated employer and employee system. It should be noted, however, that the present invention does not need organizational entity accounts and may be embodied as simply as a single employer account and a single employee account based upon that single employer account.

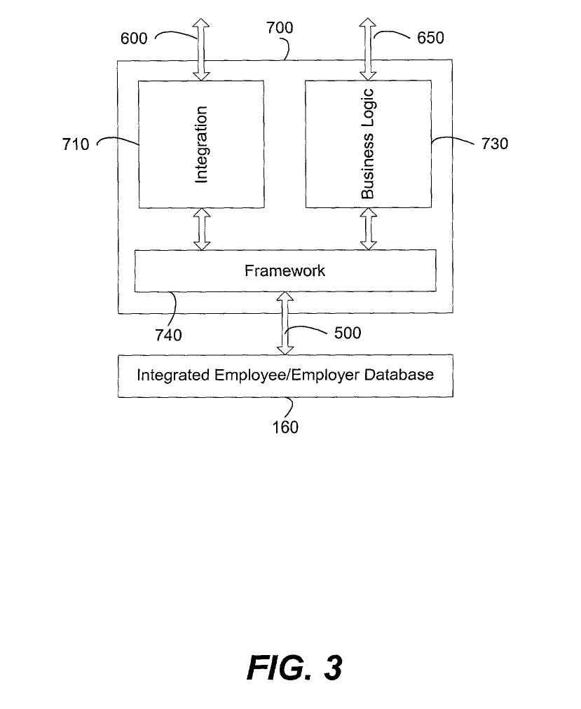

FIG. 3 depicts a more detailed view of the business logic and integration tier 700 that was first shown in FIG. 1. This tier consists of the integration system 710 and the business logic system 730 supported by framework system 740. The integration system 710 communicates to third party systems through the interface 600. The business logic system communicates to the network through interface 650. Framework system 740, which interfaces with both integration system 710 and business logic system 730, communicates with the integrated employer and employee database system 160 via interface 500. The framework system 740 may actually consist of one or more frameworks. Common merchant frameworks that might be used at this level include Microsoft COM/DCOM (Component Object Model/Distributed Component Object Model) and J2EE (Java 2 Enterprise Edition) implementations such as those from BEA Systems WebLogic, IBM WebSphere, and other J2EE compliant frameworks.

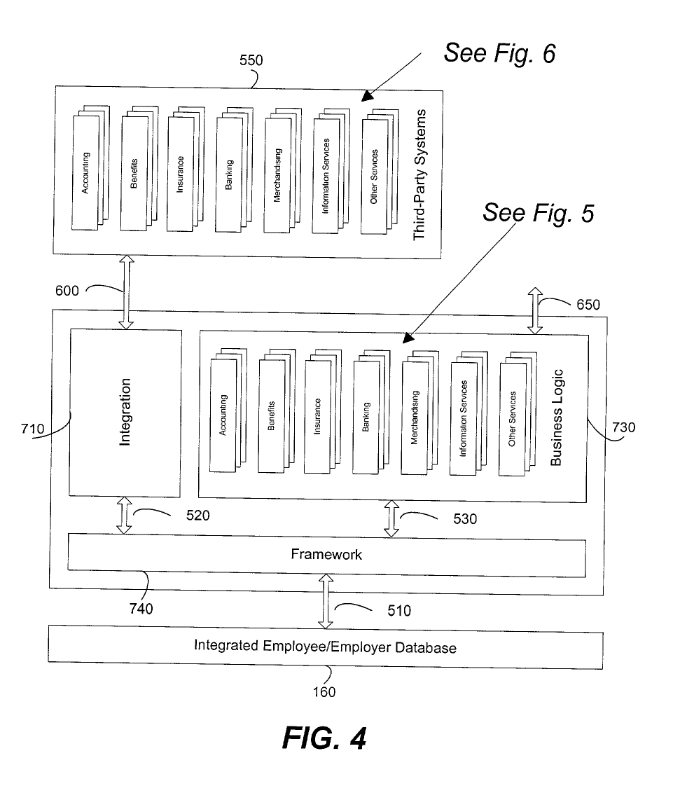

The second-level tier shown in FIG. 3 is shown in more detail in FIG. 4. The third-party system 550 and the business logic system 730 are depicted supporting the following services: Accounting; Benefits; Insurance; Banking; Merchandising; Information Services; and, Other Services.

These services are provided to either the customer or a customer services representative if embodied in 730 and are provided by third party applications to either the customer or customer service representatives of third parties if embodied in 550.

If these services are provided by 730, then these are made available to the presentation tier through interface 650. System 730 is responsible for providing the business rules that constitute these services; access to the integrated employer and employee database 160 must be made through interface 530 to the framework 740 and through interface 510 from the framework 740 to the integrated employer and employee database 160.

If these services are provided by 550, then these services must be given access to the integrated employer and employee database 160 through interface 600 to the integration system 710. The integration system uses interface 520 to access framework 740 that in turn uses interface 510 to access the integrated employer and employee database 160.

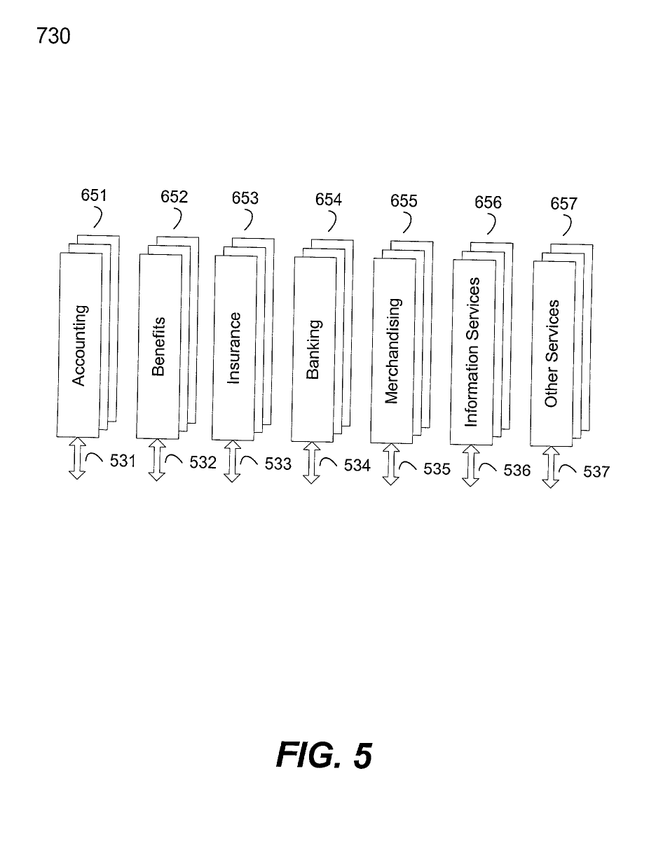

System 730 is shown in detail in FIG. 5. This system provides the business rules for the providing services directly to the customer or to a customer service representative in the present invention. By “business rules” this means that the core logic of these services are embedded in system 730. Thus, the following may be observed in this figure.

The accounting system 651 is used to provide accounting services; the interface 531 is provided such that the accounting system can access the integrated employer and employee database.

The benefits system 652 is used to provide benefits services; the interface 532 is provided such that the benefits system can access the integrated employer and employee database.

The insurance system 653 is used to provide insurance services; the interface 533 is provided such that the insurance system can access the integrated employer and employee database.

The banking system 654 is used to provide banking services; the interface 534 is provided such that the banking system can access the integrated employer and employee database.

The merchandising system 655 is used to provide merchandising services; the interface 535 is provided such that the merchandising system can access the integrated employer and employee database.

The information services system 656 is used to provide information services; the interface 536 is provided such that the information services system can access the integrated employer and employee database.

The other services system 657 is used to provide other services; the interface 537 is provided such that the other services system can access the integrated employer and employee database.

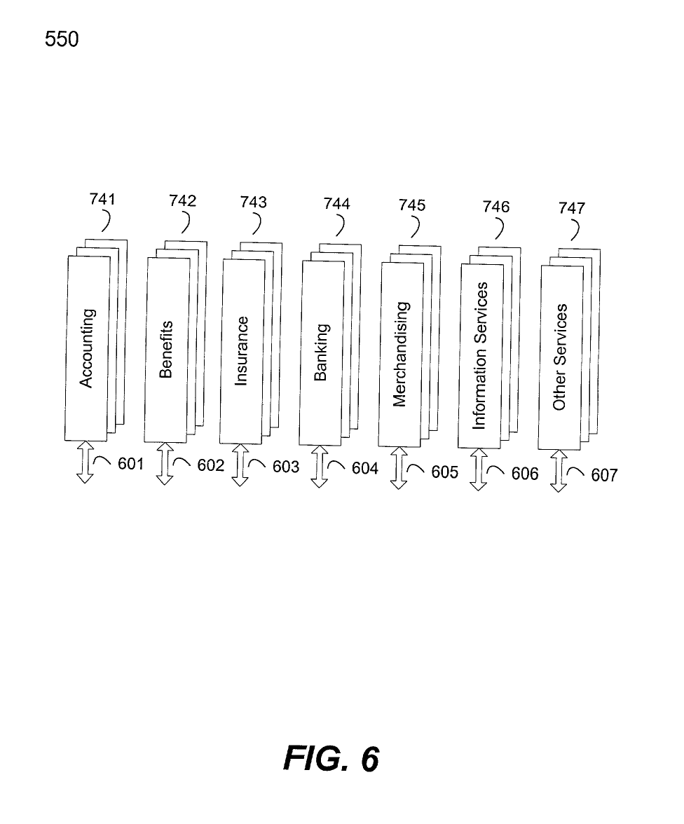

System 550 is shown in detail in FIG. 6. This system is the third party systems that may access the integrated employer and employee database. Thus, the following may be observed in this figure.

The accounting system 741 is used to provide accounting services; the interface 601 is provided such that the accounting system can access the integrated employer and employee database.

The benefits system 742 is used to provide benefits services; the interface 602 is provided such that the benefits system can access the integrated employer and employee database.

The insurance system 743 is used to provide insurance services; the interface 603 is provided such that the insurance system can access the integrated employer and employee database.

The banking system 744 is used to provide banking services; the interface 604 is provided such that the banking system can access the integrated employer and employee database.

The merchandising system 745 is used to provide merchandising services; the interface 605 is provided such that the merchandising system can access the integrated employer and employee database.

The information services system 746 is used to provide information services; the interface 606 is provided such that the information services system can access the integrated employer and employee database.

The other services system 747 is used to provide other services; the interface 607 is provided such that the other services system can access the integrated employer and employee database.

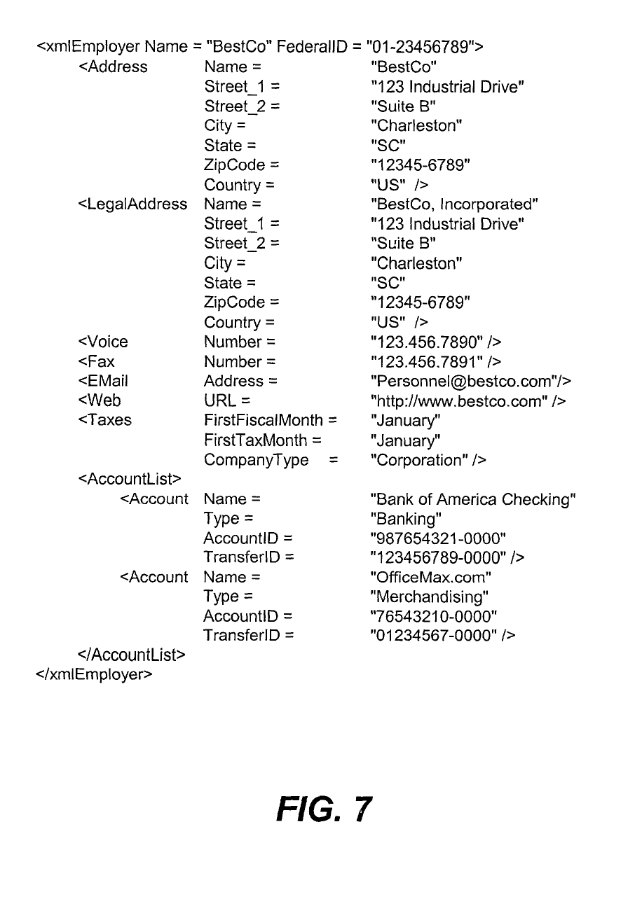

A sample fragment of potential employer account information is depicted in FIG. 7. This in no way is meant to represent all of the information associated with an employer account but is simply included for illustrative purposes only. In addition, the information is shown in an XML format for illustrative purposes only, the actual syntax of the data representation may be represented via relational database schema, object oriented database schema, proprietary or standard XML schema, or any other type of schema.

The two primary attributes of the employer account in this example are the corporate entity name and the federal identification of the corporate entity. Underlying fields in the employer account include the corporate address, the legal corporate address, contact information, tax information, and an account list. The account list is a list of accounts and associated account information for each account for the corporate entity.

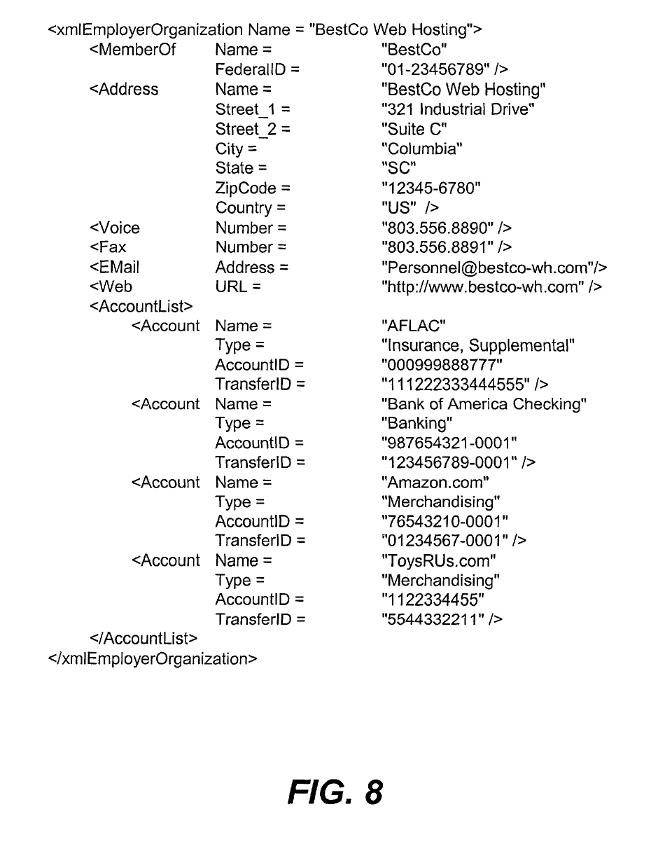

A sample fragment of potential employer organizational entity account information is depicted in FIG. 8. This in no way is meant to represent all of the information associated with an employer account but is simply included for illustrative purposes only. In addition, the information is shown in an XML format for illustrative purposes only, the actual syntax of the data representation may be represented via relational database schema, object oriented database schema, proprietary or standard XML schema, or any other type of schema.

The primary attribute of the employer organizational entity account in this example is the name of the organizational entity. Underlying fields in the employer organizational entity account include the employer of which the employer organization entity is a member, the address of the employer organizational entity, contact information, and an account list for the organizational entity. The account list is a list of accounts and associated account information for each account for the employer organizational entity.

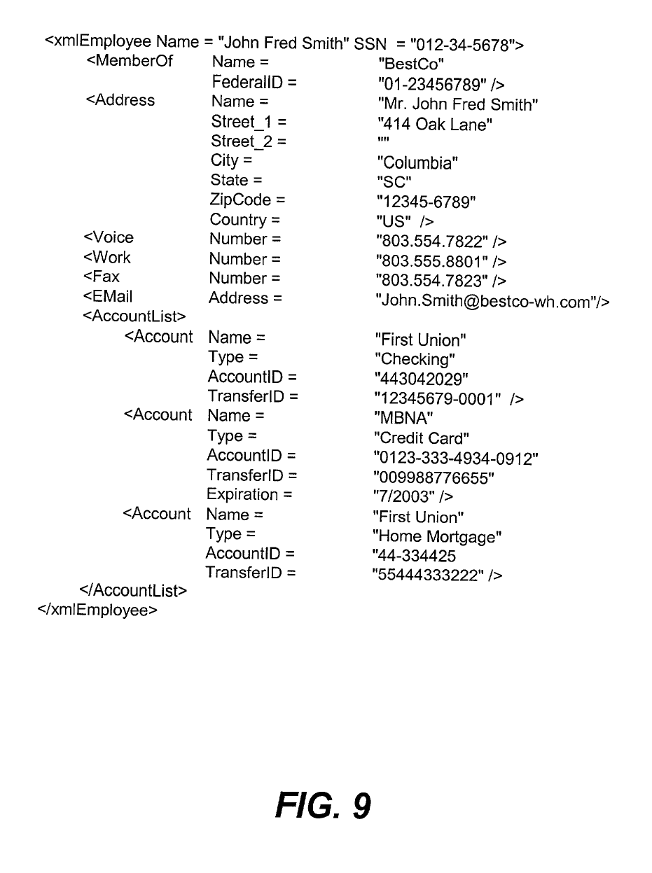

A sample fragment of potential employee account information is depicted in FIG. 9. This in no way is meant to represent all of the information associated with an employer account but is simply included for illustrative purposes only. In addition, the information is shown in an XML format for illustrative purposes only, the actual syntax of the data representation may be represented via relational database schema, object oriented database schema, proprietary or standard XML schema, or any other type of schema.

The primary attribute of the employee is the name and the social security number of the employee. Underlying fields in the employee account include the employer of which the employee is a member, the address of the employee, contact information for the employee, and an employee-specific account list. The account list is a list of accounts and associated information for each account for the employee.

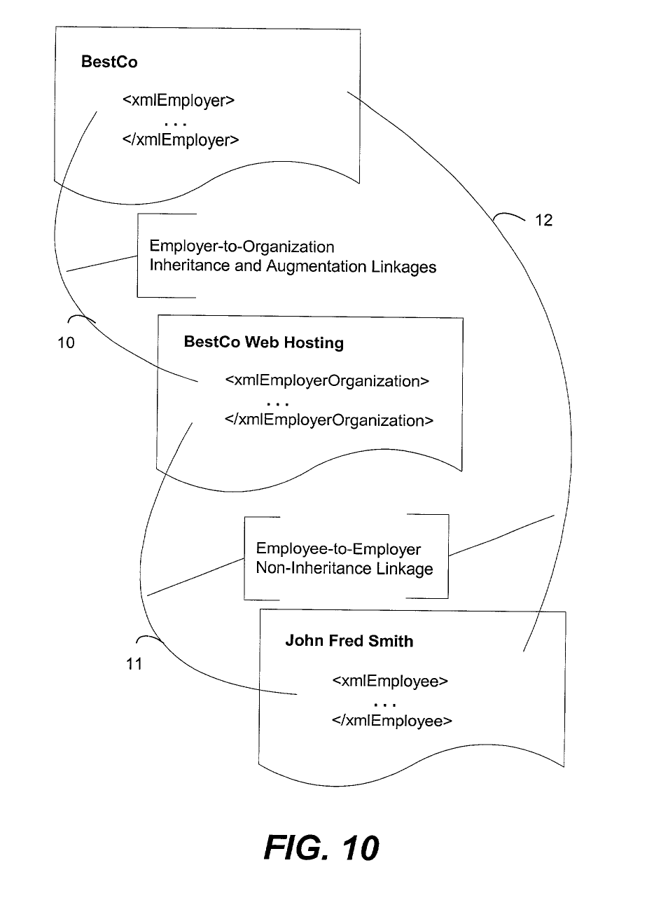

A critical element of the present invention is the linkage among the employer, employer organizational entity, and employee accounts within an integrated employer and employee meta-account. An example of the type of linkage that is available is illustrated in FIG. 10. This high-level diagram depicts the following types of linkages

One type of link is an employer-to-organization inheritance linkage between the employer and an organizational entity of that employer. This is shown graphically by 10.

Another type of link is an employer-to-organization augmentation linkage between the employer and an organizational entity of that employer. This is shown graphically by 10.

Another type of link is an employee-to-employer non-inheritance linkage between an employee and an organizational entity of an employer. This is shown graphically by 11.

Another type of link is an employee-to-employer non-inheritance linkage between an employee and an employer. This is shown graphically by 12.

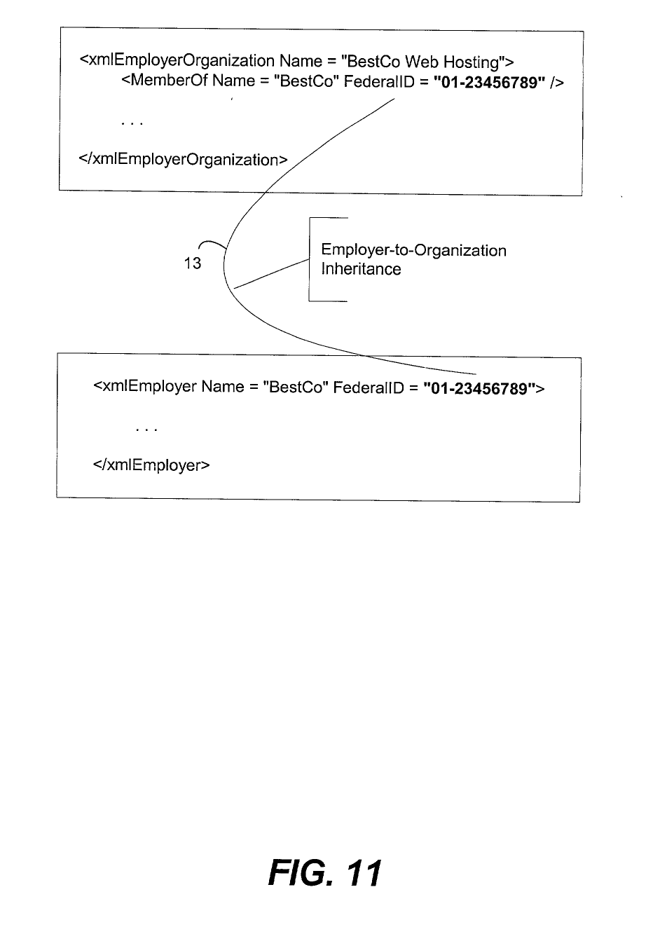

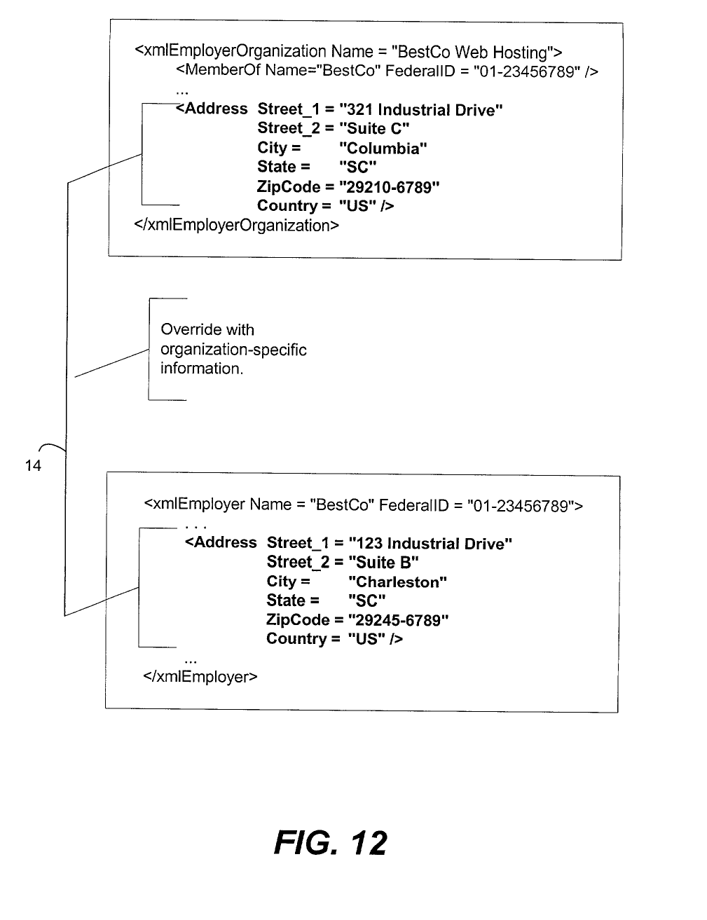

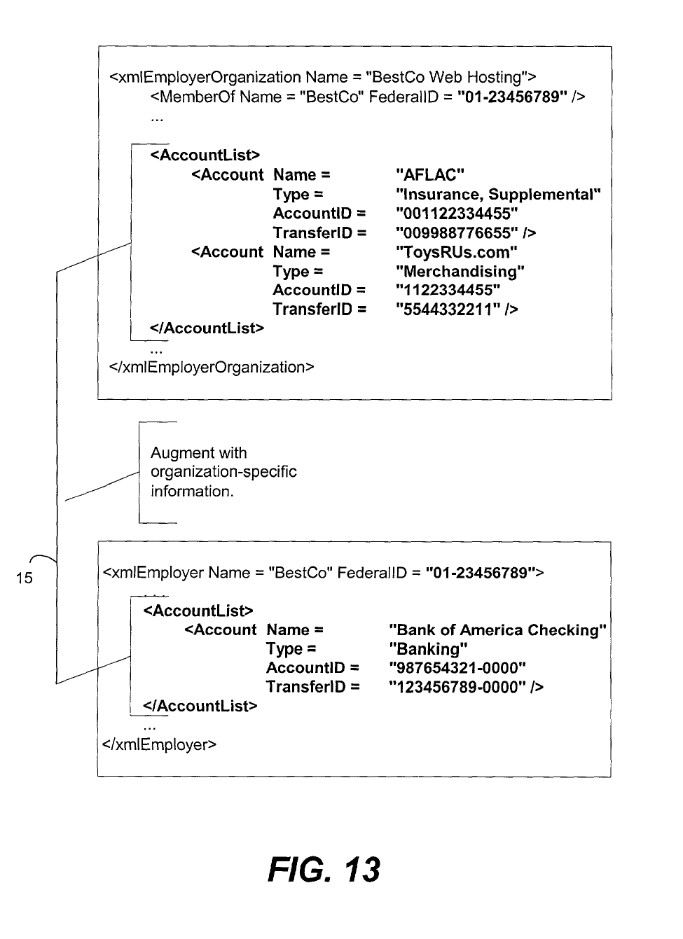

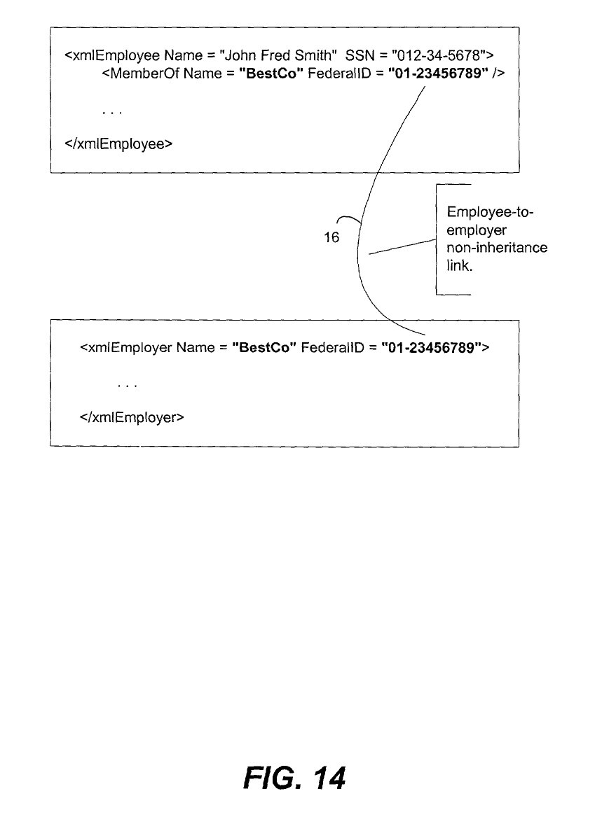

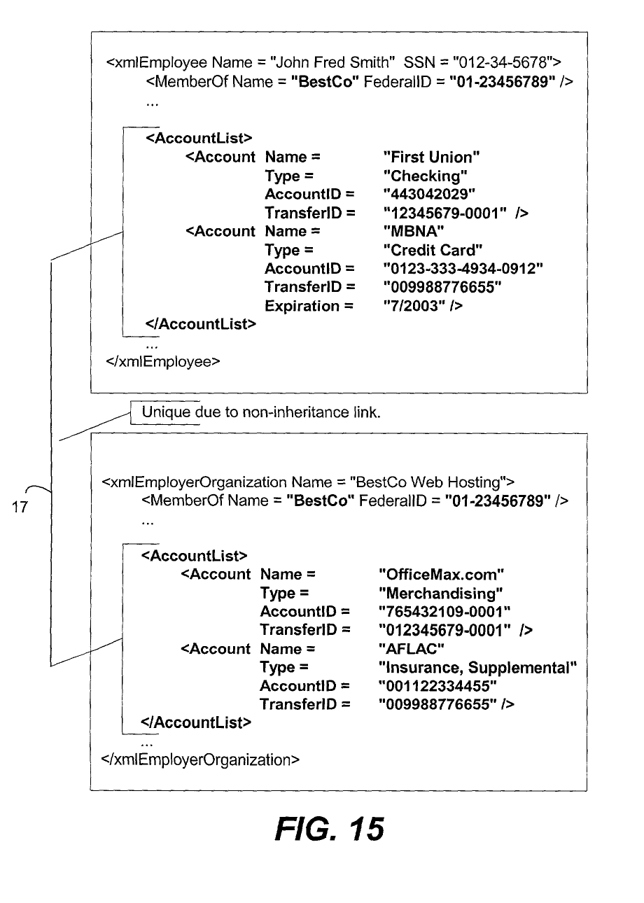

These links will be explored in FIG. 11, FIG. 12, FIG. 13, FIG. 14, and FIG. 15.

An employer organizational entity account fragment and an employer account fragment are depicted in FIG. 11. An employer-to-organization inheritance link is depicted by 13. This link is between the key attribute of the employer of the federal identification and an explicit link to that federal identification key through the “Member Of” element as shown. This linkage enables attributes of the employer to be inherited by the employer organizational entity. It is through this mechanism that all organizational entities of an employer may share common employer attributes without redundancy.

An employer organizational entity account fragment and an employer account fragment are depicted in FIG. 12. An employer-to-organization inheritance link that overrides the employer's basic attributes is depicted by 14. This link is between the address fields of the employer account and the employer organizational entity account. In this example, the organizational entity account overrides the address information originally specified in the employer account. The result of this is a unique address for organizational entities that have different physical addresses from their corporate parent.

An employer organizational entity account fragment and an employer account fragment are depicted in FIG. 13. An employer-to-organization inheritance link that augments the employer's basic attributes is depicted by 15. This link enables an organization to supplement the information (in this case, the account list) that is by default inherited by the employer organization entity from the employer. In this example, the employer organization entity inherits the Bank of America checking account and augments that with an AFLAC and a ToysRUs.com account.

An employee account fragment and an employer account fragment are depicted in FIG. 14. An employee-to-employer non-inheritance link is depicted by 16. This link shows membership, but in this case does not confer inheritance by the employee for the employer attributes.

An employee account fragment and an employer organization entity account fragment are depicted in FIG. 15. As introduced in FIG. 14, the link type of link 17 is a non-inheritance link. This means that the employee account does not inherit the account attributes of the employer organization entity. Thus, in this example, the AFLAC account and the OfficeMax.com account are not inherited by the employee; instead, the First Union and the MBNA accounts are all that the employee will actually see and be able to access and manage.

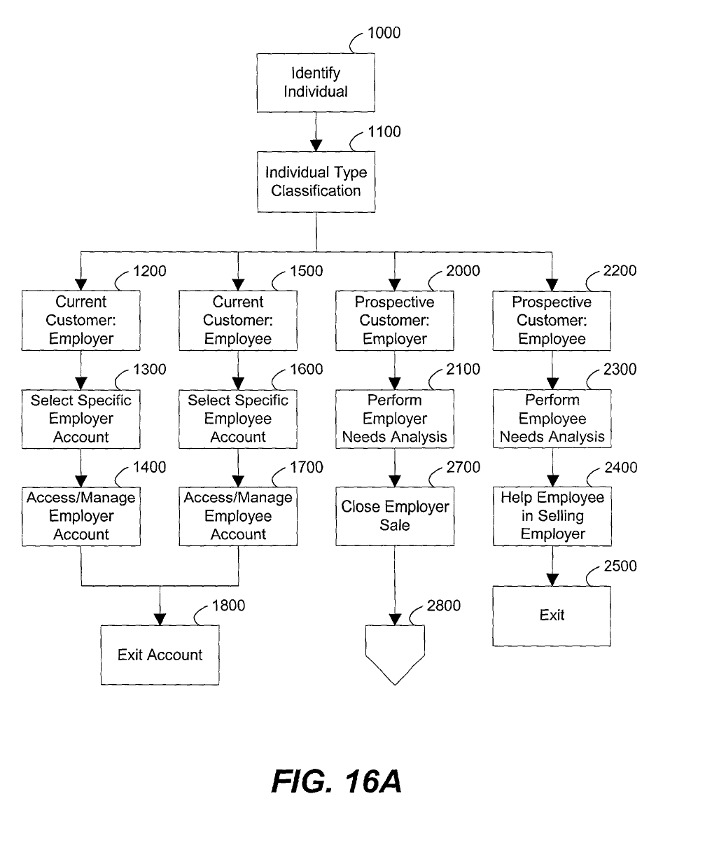

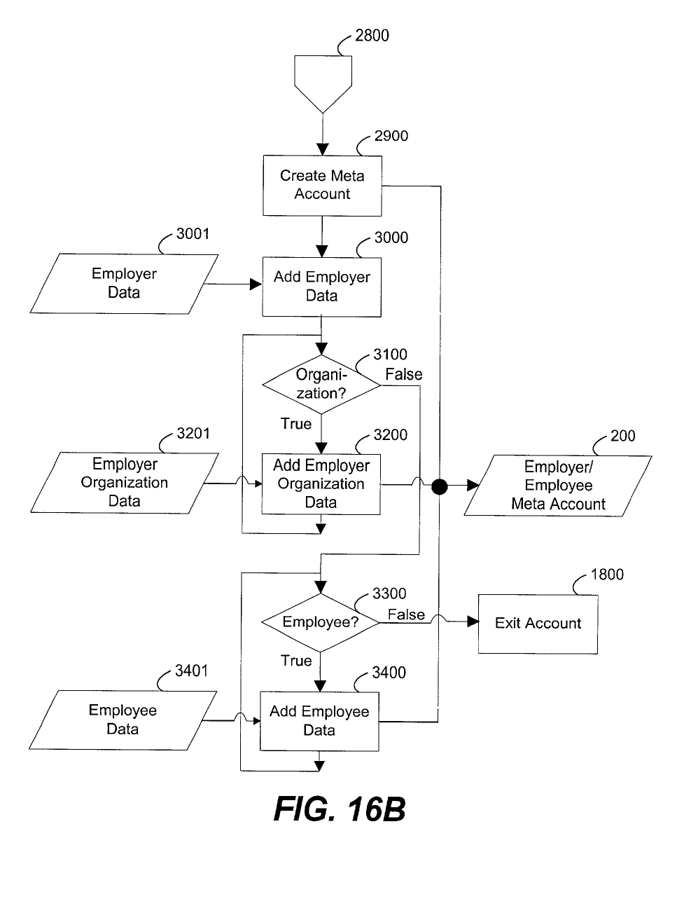

The high-level session-oriented access and management of the present invention is depicted in FIG. 16A and 16B. The first step is the identification of the individual as shown in process step 1000. Once the individual is identified to the system, that individual may be classified as shown in process step 1100. There are two basic classifications of customers: current customers and prospective customers. Current customers are afforded the opportunity to access and manage their accounts. Prospective customers are afforded the opportunity to become current customers by creating accounts if appropriate.

If the individual is classified as a current customer who represents an employer, then process step 1200 is selected. At that point, process step 1300 is enacted in which the selection of the specific employer account occurs. Note that this selection may be of the base employer account or an employer organizational entity account. Once that selection has been completed, then the actual access and management of that account occur as depicted by process step 1400. Once that access and management is completed by the current customer representing an employer, the account is exited as shown in process step 1800.

If the individual is classified as a current customer who represents an employee, then process step 1500 is selected. At that point, process step 1600 is enacted in which the selection of the specific employee account occurs. Once that selection has been completed, then the actual access and management of that account occur as depicted by process step 1700. Once that access and management is completed by the current customer representing an employee, the account is exited as shown in process step 1800.

If the individual is identified as a prospective customer representing an employee, then process step 2200 is selected. This leads to process step 2300, in which a needs analysis is performed of the employee. After that needs analysis is completed, the employee is enlisted in assisting in having the employee's employer enroll to use the services of the present invention in process step 2400. After that assistance is completed, the session is exited as depicted in process step 2500.

If the individual is identified as a prospective customer representing an employer, then process step 2000 is selected. This leads to process step 2100, in which a needs analysis is performed, and then to process step 2700, in which the potential customer representing an employer is convinced to enroll to use the services of the present invention. It is assumed that this assistance is successful. This leads to process step 2800, which is an off-page reference that leads to the continuation of this in FIG. 16B).

In FIG. 16B, the next step shown after continuation process step 2800 is the creation of the previously described meta-account as depicted in process step 2900. It is in this step that the integrated employer and employee meta-account, as depicted by data element 200, is created and initialized as an empty meta-account. After the meta-account has been created, process step 3000 occurs in which the employer data is received as data element 3001 and added to the integrated employer and employee meta-account 200. The employer data 3001 may be created either directly by the customer representing the employer or indirectly by a customer service representative interviewing the customer representing the employer.

After the employer account information has been entered, a decision must be made concerning whether employer organizational entity accounts should be created. This is depicted as decision element 3100. If there are no more organizational entity accounts that should be created, then control is transferred to decision element 3300. If there is an employer organizational entity that remains that should be created, then process step 3200 occurs. In process step 3200, the employer organization entity data is received as data element 3201 and added to the integrated employer and employee meta-account 200. The employer organization entity data 3201 may be created either directly by the customer representing the employer or indirectly by a customer service representative interviewing the customer representing the employer. After this occurs, control is transferred back to decision element 3100 in order to test to find if any other employer organization entity accounts should be created.

Decision element 3300 is reached only when there are no employer organizational entities remaining for which accounts should be created. At this point, a test occurs to determine if there are any more employees for which to add employee accounts. If not, then the account and the session are exited as per process step 1800.

If an employee account is to be added, then the employee data 3401 is collected by process step 3400 and added to the integrated employer and employee meta-account 200. The employee data 3401 may be created either directly by the customer representing the employer or indirectly by a customer service representative interviewing the customer representing the employer. After this employee account is created, control is transferred back to decision step 3300 so that more employee accounts may be created if more remain that should be created.

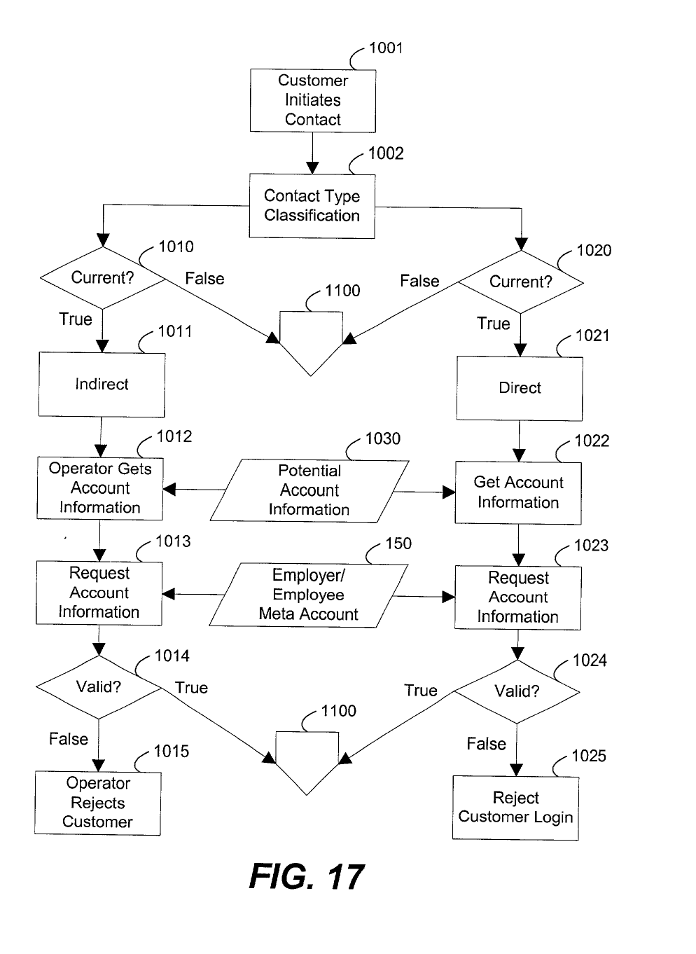

The customer identification flow is depicted in more detail in FIG. 17. This figure depicts the direct and indirect methods that may be used by a customer to gain access to the functionality of the present invention.

The first step is that the customer must initiate contact, or must respond to contact initiated by some organization, and is depicted as process step 1001. At that point, contact type classification must occur as per process step 1002. This leads to decision step 1010 or 1020 depending on whether the contact type is indirect (via a customer service representative) or direct. In either case, if the customer is not a current customer but instead is prospective, control is transferred to an off-page reference 1100.

If the customer type is current and the contact type is indirect 1011, then the customer service representative retrieves the appropriate account information 1030 as depicted by process step 1012. That information is then compared against existing information in the appropriate integrated employer and employee meta-account 150 as depicted by process step 1013. If the customer service representative confirms that the information matches, then control is transferred to an off-page reference 1100. If the information does not match, then the customer service representative rejects the customer.

If the customer type is current and the contact type is direct 1021, this means that the customer is attempting to access the functionality of the present invention directly (i.e., the customer is attempting to log into the system). The first process step that must be taken is to retrieve the potential customer account information 1030 from that customer as depicted by process step 1022. After that, the integrated employer and employee meta-account 150 is requested by process step 1023. If the customer is found to be valid (i.e., the information matches) 1024, then control is transferred to an off-page reference 1100. If the information does not match, then the customer request to access the functionality of the present invention is rejected.

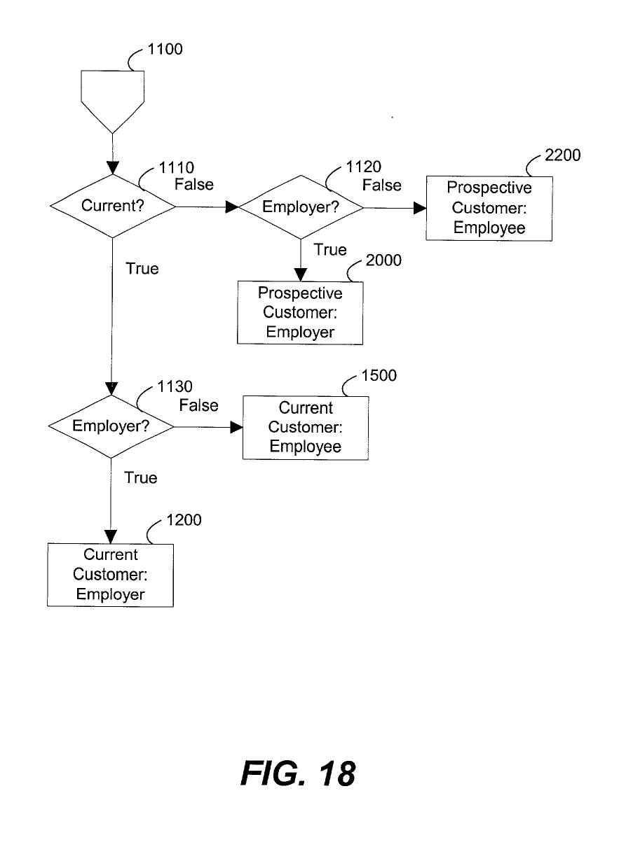

The off-page reference 1100 referenced in the last few paragraphs may be found in FIG. 18. This figure represents at a more detailed level the individual type classification 1100 that was depicted at a higher level in FIG. 16A. The purpose of the diagram flow depicted in FIG. 18 is to classify the customer as either a current or a prospective customer, and as either an employer or an employee.

If the individual is not a current customer as determined in decision step 1110 and is not an employer as determined in decision step 1120, then that individual is a prospective customer who is an employee as per 2200. If the individual is not a current customer as determined in decision step 1110 and is an employer as determined in decision step 1120, then that individual is a prospective customer who is an employer as per 2000.

If the individual is a current customer as determined in decision step 1110, then control is passed to decision step 1130. If the individual is an employer as determined in decision step 1130, then the individual is a current customer who is an employer as per 1200. If the individual is an employee as determined in decision step 1130, then the individual is a current customer who is an employee as per 1500.

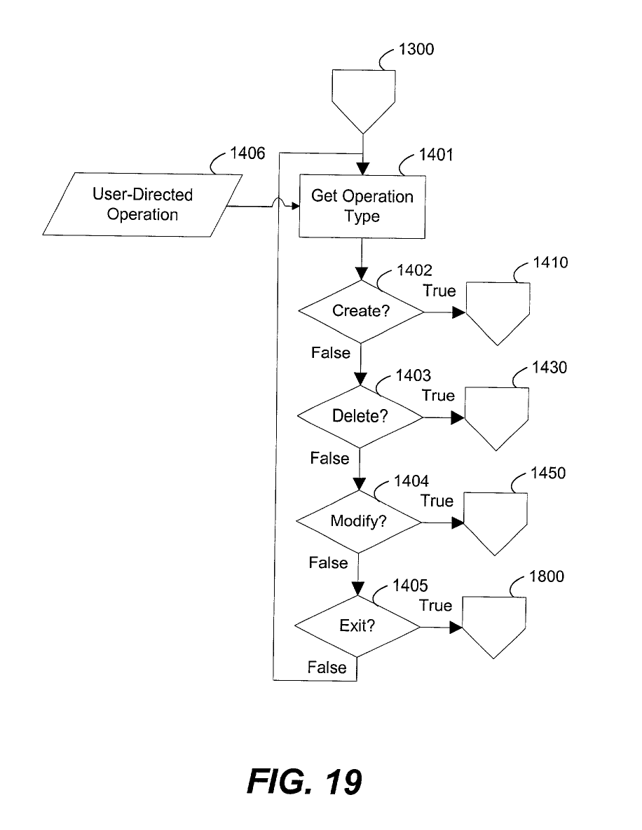

The flow diagram for the access and management of a specific employer account is depicted in FIG. 19. The first step that must be taken is to determine the type of operation the customer representing the employer wishes to perform. This is depicted in process step 1401 in which the operation type is received by reading the user-directed operation data element 1406. There are four operation types: create an employer account, delete an employer account, modify an employer account (which includes both read and write operations), and exit from this set of operations.

If the operation type is creating an employer account as depicted by 1402, then an off-page control 1410 is enacted. If the operation type is deleting an employer account as depicted by 1403, then an off-page control 1430 is enacted. If the operation type is modifying an employer account as depicted by 1404, then an off-page control 1450 is enacted. If the operation type is to exit, then an off-page control 1800 is enacted. If the operation type is unknown, then an attempt is made to get another user-directed operation.

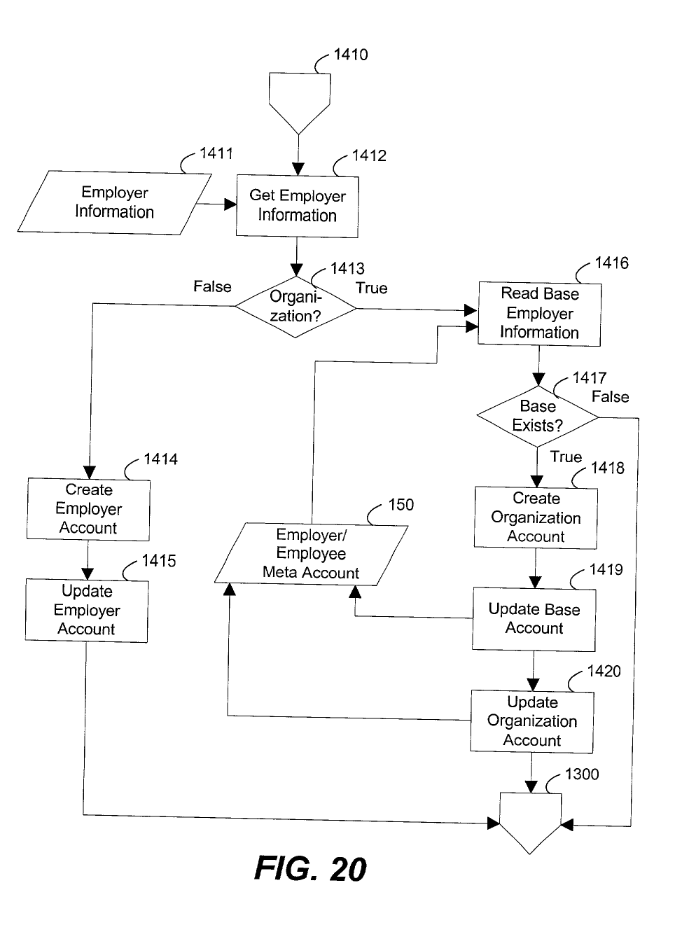

The creation of an employer account is depicted in FIG. 20. The first process step in creating an employer account is to get the employer information from the customer representing the employer as depicted by the process step 1412 retrieving the data element 1411. If the employer account does not represent an employer organizational entity as determined by decision step 1413, then the employer account must be created and that employer account must be updated with the information from data element 1411 as shown in process step 1415.

If the employer account does represent an employer organizational entity as determined by decision step 1413, then the base employer account information from 150 must be read as per process step 1416. Note that this base employer account may be either an employer account or an employer organizational entity account. If this base employer account exists, then an employer organizational entity account must be created as shown in process step 1418. This creation also entails the modification of the base account, which is then updated in process step 1419 to the data element 150. The newly created employer organizational entity account is then updated to data element 150 as depicted by process step 1420. At that point, control is transferred to the off-page reference depicted by 1300.

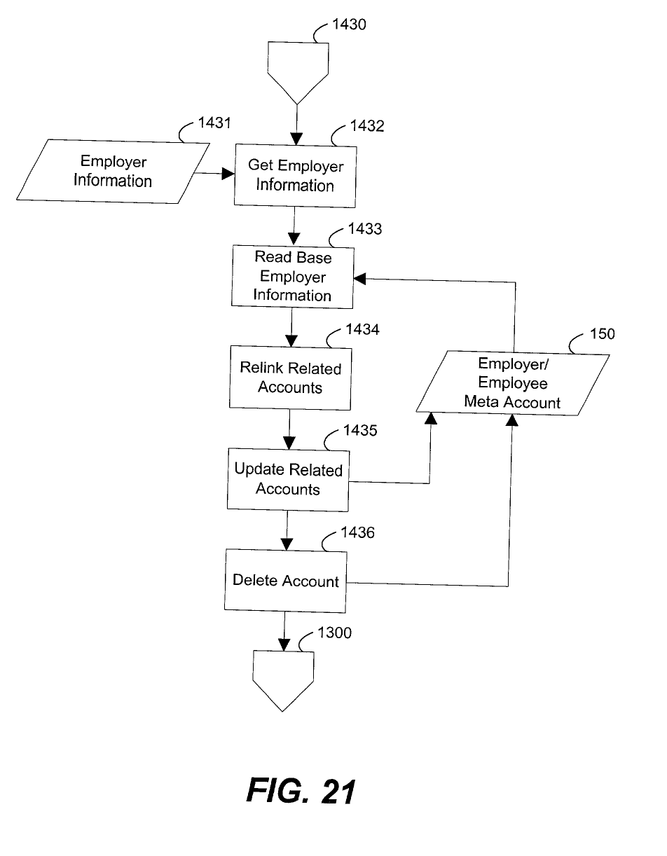

The deletion of an employer account is depicted in FIG. 21. The first process step is to retrieve the employer information 1431 from the customer representing the employer as depicted by process step 1432. At that point, the base employer account is read as depicted by step 1433 from the integrated employer and employee meta-account data element 150. Note that if the account being deleted is the lowest-level employer account, then that is noted and process step 1433 simply reads the account that will be deleted.

Process step 1434 depicts the process step of relinking all related accounts such that the employer account that is to be deleted may be deleted while the integrity of the employer and employee meta-account is maintained. What occurs in this process step is that all accounts that implicitly or explicitly rely upon the account to be deleted are updated such that each account relies upon the correct account without the presence of the account to be deleted. At that point, these related accounts are updated as per process step 1435 into data element 150 of the present invention and the account that was specified to be deleted is deleted as shown in process step 1436 and the integrated employer and removed from the employee meta account 150. Control is then transferred to the off-page reference 1300.

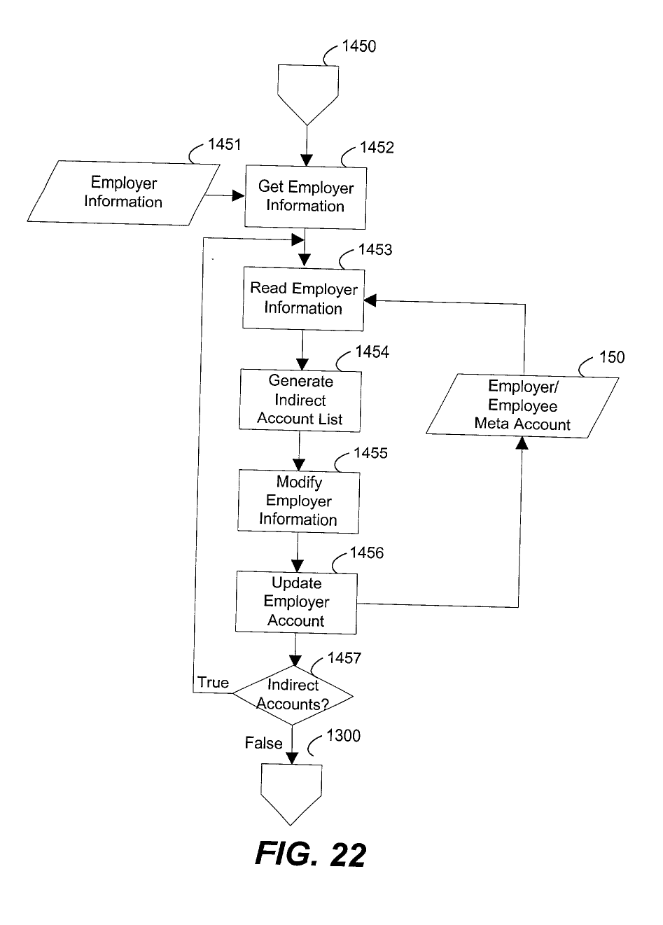

The modification of an employer account is depicted in FIG. 22. Note that because a modification inherently must include the simple access information, simple access to the integrated employer and employee meta-account is included in this figure.

The first action shown is the retrieval of employer information 1451 from the customer representing the employer as depicted by process step 1452. At that point, the specific employer account is read from the integrated employer and employee meta-account 150 as per process step 1453. This constitutes the full of any access operation.

The next process step, 1454, is the generation of an indirect account list. This is crucial because the modification of certain employer account information can result in the modification of other accounts due to the relationships that exist on an employer-to-employer and employer-to-employee basis. Once this list has been generated, the employer information is modified as shown in process step 1455 and the employer account within the integrated employer and employee metaaccount 150 is updated in process step 1456.

If any indirect account modifications are necessary, this is detected in decision step 1457 and the flow diagram process step 1453 onward is repeated. This cycle repeats until no more indirect accounts remain that require modification. This process is inherently recursive in nature because each iteration may generate more indirect accounts that require subsequent modification.

When no more indirect accounts remain that require modification, control is transferred to the off-page reference 1300.

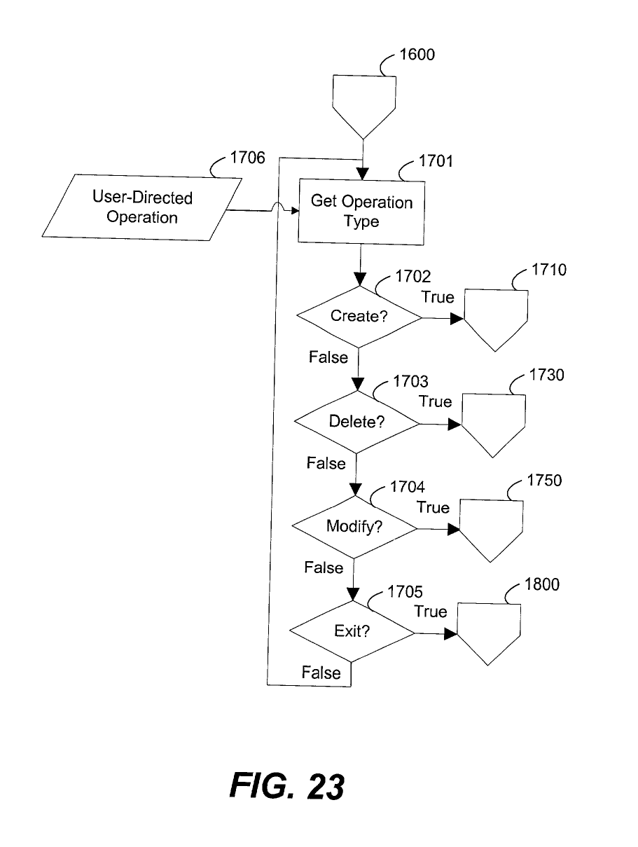

The flow diagram for the access and management of a specific employee account is depicted in FIG. 23. The first step that must be taken is to determine the type of operation the customer representing the employer wishes to perform. This is depicted in process step 1701 in which the operation type is received by reading the user-directed operation data element 1706. There are four operation types: create an employee account, delete an employee account, modify an employee account (which includes both read and write operations), and exit from this set of operations.

If the operation type is creating an employer account as depicted by 1702, then an off-page control 1710 is enacted. If the operation type is deleting an employer account as depicted by 1703, then an off-page control 1730 is enacted. If the operation type is modifying an employer account as depicted by 1704, then an off-page control 1750 is enacted. If the operation type is to exit, then an offpage control 1800 is enacted. If the operation type is unknown, then an attempt is made to get another user-directed operation.

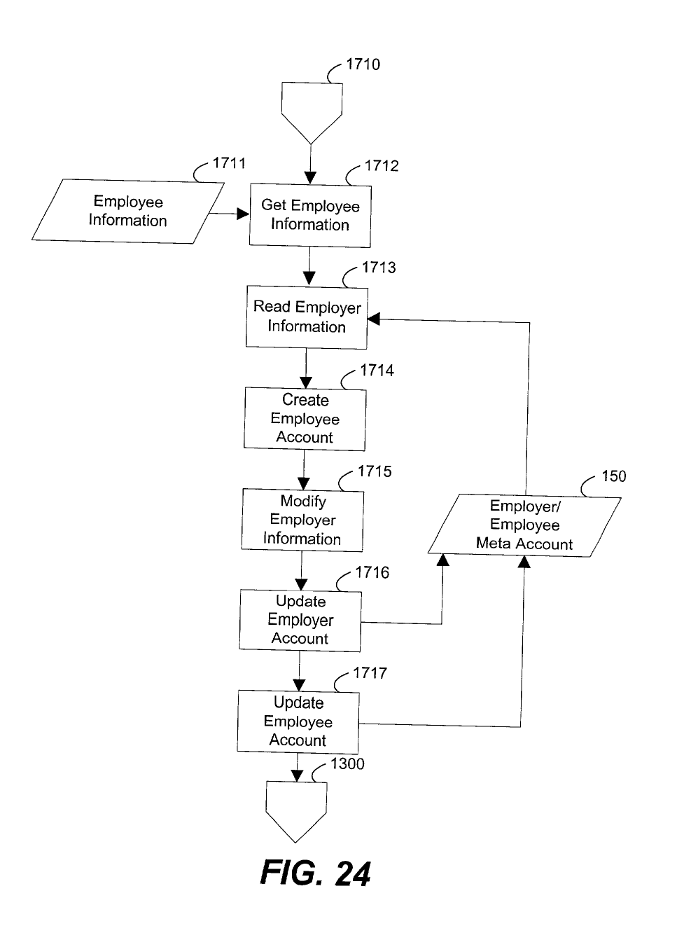

The creation of an employer account is depicted in FIG. 24. The employee information is retrieved as data element 1711 by process step 1712. The appropriate employer account (the employer of the specified employee) is then read from data element 150 in process step 1713.

The specified employee account is created in process step 1714. The previously read employer account information is modified in process step 1715 and that employer account is then updated in process step 1716 by writing to data element 150. The employee account is updated to the integrated employee and employer meta-account represented by data element 150 in process step 1717. At that point, control is transferred to the off-page reference 1300.

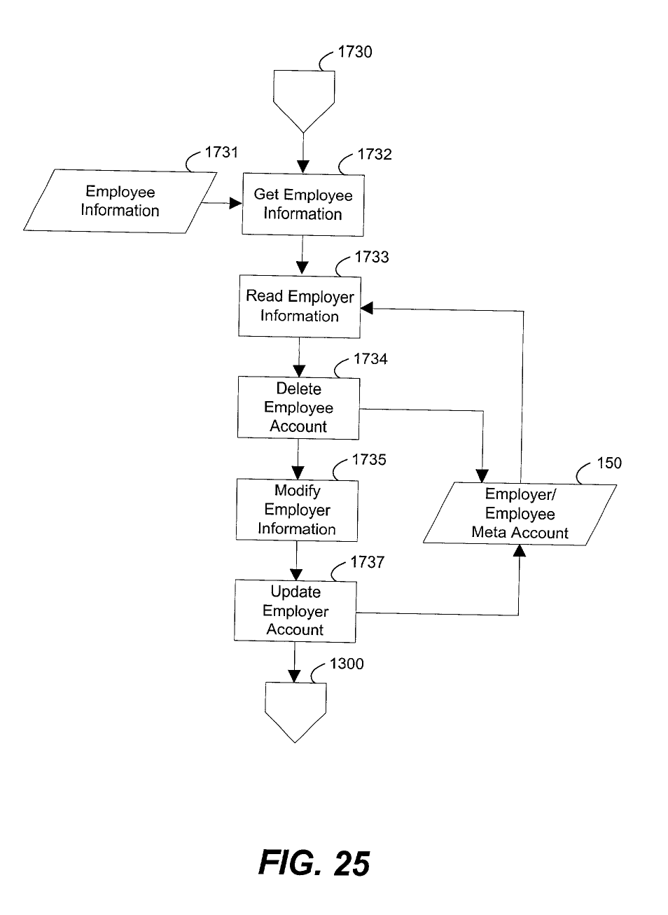

The deletion of an employer account is depicted in FIG. 25. The employee information is retrieved as data element 1731 by process step 1732. The appropriate employer account (the employer of the specified employee) is then read from data element 150 in process step 1733.

At that point, the specified employee account is deleted as shown in process step 1734 from the integrated employee and employer meta-account 150. The employer information is modified to reflect the fact that the employee account has been deleted as shown in process step 1735. The next step is that the employer account is updated in data element 150. At that point, control is then transferred to the off-page reference 1300.

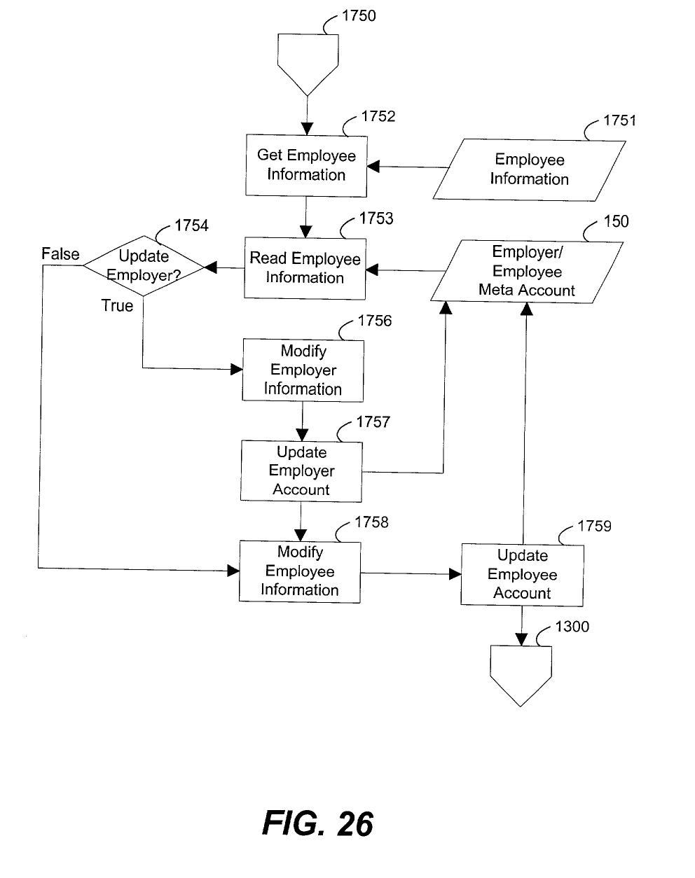

The modification of an employer account is depicted in FIG. 26. Note that because a modification inherently must include the simple access information, simple access to the integrated employer and employee meta-account is included in this figure.

The employee information data element 1751 is retrieved by process step 1752. At that point, the employee account specified in that operation is read from the integrated employer and employee meta-account 150 by process step 1753. This constitutes simple access to the employee account.

When the employee information is accessed, control is transferred to decision step 1754 in which it is determined whether the employee account information that must be updated requires the employer information also be updated. If an employer update is required, then control is transferred to process step 1756 where the employer information is modified. After the employer information is modified it is updated to data element 150 by process step 1757.

After the employer account has been updated, or if in decision step 1754 it is determined that the employer account does not need to be updated, process step 1758 occurs in which the employee information is modified. After the employee information is modified, it is updated into data element 150 by process step 1759. At that point, control is transferred to off-page reference 1300.

It is thus seen that the computerized system of this invention provides an improved full service employer and employee system and integrates the interactions among and between the employer and the employee and other third parties. It is further seen that the computerized system of this invention provides not only such a system, but also provides such a system that provides not just to the needs of the employer or just to the needs of the individuals employed by the employer. A perfect example of a marketing opportunity associated with the use of the invention is associated with a payroll processing entity. Such a system of this invention would provide for the offering, for example, of property casualty insurance, affordable employee benefit plans, and target effective human resource services, comprehensive payroll services, cost effect of workman's comp programs, 401K savings plans, flexible benefit plans and information services and internet assistance.

As many variations will become apparent to those with skill in the art from a reading of the foregoing description, which are exemplary in nature, such variations are embodied within the spirit and scope of the invention as defined by the following appended claims.

What is claimed is:

1. A computerized system for the integration of employer and employee data, comprising:
a. data repository for storing integrated employer and employee meta-accounts;
b. an integration system that enables third party applications to access said data repository;
c. a presentation system to provide interface services;
d. a business logic system that provides application services to said presentation system;

2. The computerized system for employer and employee data of claim 1, further comprising:
a. a single employer account;
b. an n-tier hierarchical organizational entity account structure, where n ranges from zero to any number;
c. a series of employee accounts further comprising a relationship linkage mechanism wherein:
an inheritance relationship among 2.a, 2.b and 2.c;
a non-inheritance relationship among 2.a 2.b and 2.c, and
an augmentation relationship among 2.a, 2.b and 2.c.

3. The computerized system of claim 1 wherein said services of said business logic systems comprise:
a. accounting services;
b. benefits services;
c. insurance services;
d. banking services;
e. merchandising services; and
f. information services.

4. The computerized system of claim 1 wherein said presentation system permits a customer to directly access and manage the services of said business logic system.

5. The computerized system of claim 3 wherein said presentation system enables a customer service representative to directly access and manage the services of said business logic system.

6. The computerized system of claim I wherein said presentation system enables a user to access and manage the services of said business logic, using an access device selected from the group of:
a. a kiosk;
b. a telephone using touch-tones and/or voice;
c. a personal digital assistant; and
d. a personal computer.

7. A method of identifying individuals using the system of claim 1 through a customer service representative.

8. A method of identifying individuals using the system of claim 1 directly through a login process either through said integration system or through said presentation system.

9. A method of classifying individuals using the system of claim 1 as either a current customer or a prospective customer, and further as a representative of an employer or an employee.

10. The computerized system of claim 2 comprising:
employer organization entity accounts.

11. The computerized system of claim 1 wherein said services comprise:
a service by service providers.
